(19) United States
(12) Patent Application Publication
(10) Pub. No.: US 2012/0193286 A1
(43) Pub. Date: Aug. 2, 2012

(54) METHOD FOR PRODUCING A NANOPOROUS POLYURETHANE-BASED COATING

(75) Inventors: Frank Prissok, Lemfoerde (DE); Marc Fricke, Osnabrueck (DE); Stefan Schliebe, Huede (DE)

(73) Assignee: BASF SE, Ludwigshafen (DE)

(21) Appl. No.: 13/500,664

(22) PCT Filed: Oct. 12, 2010
(86) PCT No.: PCT/EP2010/065261

§ 371 Date: Apr. 6, 2012

(30) Foreign Application Priority Data
Oct. 16, 2009 (EP) 09173323.8

(51) Int. Cl. B32B 3/26; E04B 1/82; B01D 39/14; B05D 3/04; B05D 5/00

(52) U.S. Cl. 210/510.1; 427/341; 427/244; 428/315.5; 181/286

(57) ABSTRACT

The present invention relates to a process for producing a nanoporous foam, said process comprising providing a monomeric component (A) comprising a polyfunctional isocyanate (A1) and a solvent (C), and contacting said monomeric component (A) with water vapor. The present invention further comprises a nanoporous foam obtainable by such a process and also a nanofoam composite obtainable by applying said monomeric component (A) to a carrier (B) before the step of contacting with water vapor. The nanofoam composite is useful as insulant for thermal or acoustical insulation, as filtering material or as catalyst carrier.

The present invention relates to a process for producing a nanoporous foam, said process comprising providing a monomeric component (A) comprising a polyfunctional isocyanate (A1) and a solvent (C), and contacting said monomeric component (A) with water vapor. The present invention further comprises a nanoporous foam obtainable by such a process and also a nanofoam composite obtainable by applying said monomeric component (A) to a carrier (B) before the step of contacting with water vapor. The nanofoam composite is useful as insulant for thermal or acoustical insulation, as filtering material or as catalyst carrier.

Organic nanofoams or so-called xerogels and aerogels are typically produced by the sol-gel process. In this process, a sol is produced on the basis of a reactive organic precursor to a gel and solvent and then converted into a gel via a crosslinking reaction. To obtain a porous material from the gel, the solvent has to be removed. This can be done under supercritical conditions, in which case the so-called aerogels are obtained, or below the critical pressure, in which case the so-called xerogels are obtained. Removing the solvent above the critical pressure has the disadvantage that this is very involved in terms of the equipment required, while removing the solvent under subcritical conditions by capillary forces exert a severe stress on the crosslinked structures of the gel, partly destroying them and causing the gel to shrink while losing porosity.

Known organic xerogels are constructed on the basis of phenol-aldehyde resins or on the basis of polyurethane and/or polyurea for example.

WO 2007/146945 discloses aerogel-foam composites. The aerogel-foam composites mentioned comprise especially inorganic aerogels, which are cured in foams such as those composed of polyurethane for example, followed by a drying step under super-critical conditions. The publication mentions the possible use of organic aerogels and also the use of subcritical drying. The publication uses a matrix of foam in order to reduce the inherent fragility of (inorganic) aerogels and at the same time to improve further properties of the mechanical kind such as flexibility.

Xerogels based on polyurea or polyurethane are known per se and are often mechanically superior to inorganic aerogels.

WO 2008/138978 states that xerogels based on aromatic polyurea, with diamino-diphenylmethane and polyfunctional isocyanates, can be used to obtain xerogels of low thermal conductivity and low average pore size.

However, the thermal conductivity of known xerogels is not adequate for all applications. The thermal conductivity is generally unsatisfactory for applications in the range of pressures above the vacuum range, for example in the pressure range from about 1 to about 100 mbar, but especially at atmospheric pressure. In addition, the properties of the xerogels as materials, for example the mechanical stability of the xerogel, the porosity and especially the density, are inadequate.

The problem addressed by the present invention was that of providing an alternative process for producing organic nanofoams which is inexpensive and simple to carry out.

The problem addressed by the present invention was solved by a process for producing a nanoporous foam, said process comprising providing a monomeric component (A) comprising a polyfunctional isocyanate (A1) and a solvent (C), and contacting said monomeric component (A) with water vapor.

For the purposes of the present invention, a nanoporous foam is a porous material having a porosity of at least 70% by volume and a volume-averaged average pore size of at most 50 micrometers, preferably at most 10 micrometers and at least 50 nanometers and more preferably of at most 5 micrometers and at least 100 nanometers.

Monomeric component (A) is produced by mixing polyfunctional isocyanate (A1) and solvent (C).

The polyfunctional isocyanate used can be any known organic isocyanate having a functionality greater than 1. Aliphatic, cycloaliphatic and aromatic isocyanates can be used for example. Such polyfunctional isocyanates are known per se or are obtainable by methods known per se. Polyfunctional isocyanates can more particularly also be used as mixtures, and so component (A1) in this case comprises various polyfunctional isocyanates.

Suitable isocyanates comprise for example 2,2′-, 2,4′- and/or 4,4′-diphenylmethane diisocyanate (MDI), more highly nuclear homologs of MDI, so-called polymer MDI, 1,5-naphthylene diisocyanate (NDI), 2,4- and/or 2,6-tolylene diisocyanate (TDI), 3,3′-dimethylbiphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate.

The polyfunctional isocyanate used is preferably an isocyanate-containing prepolymer. The isocyanate-containing prepolymer used in the context of the present invention can be the reaction product of polyisocyanates (a) with isocyanate-reactive compounds (b) and also optionally chain-extending and/or crosslinking agents (c), wherein the polyisocyanate (a) is used in excess.

Particularly suitable polyfunctional prepolymers have an isocyanate content of less than 30%, more preferably of 5 to 29%, even more preferably of 7 to 28% and especially of 10 to 25%.

Useful polyisocyanates (a) include all prior art aliphatic, cycloaliphatic and aromatic two- or higher-functional isocyanates and also any desired mixtures thereof. Preference is given to using the isocyanates mentioned above.

Preference is given to using 2,4-tolylene diisocyanate, 2,6-tolylene diisocyanate, 2,4′-diphenylmethane diisocyanate and 4,4′-diphenylmethane diisocyanate and more highly nuclear homologs of diphenylmethane diisocyanate (polymer MDI) and also mixtures thereof, uretoneimine especially a mixture of 2,4′-diphenylmethane diisocyanate and 4,4′-diphenylmethane diisocyanate as polyisocyanate (a).

The employed polyisocyanates (a) preferably have an average isocyanate functionality of below 3, more preferably of below 2.5 and especially of below 2.2. It is very particularly preferable for the polyisocyanates (a) to have a functionality of 2.0.

Useful isocyanate-reactive compounds (b) include all compounds having at least two hydrogen atoms reactive with isocyanate groups. Preference is given to using polyesterols, polyetherols, or mixtures of polyetherols with polyols having a tertiary amine group especially polyetherols.

Polyols having tertiary amino groups are obtainable for example by reaction of secondary amines, for example ethylenediamine, with alkylene oxides, for example ethylene oxide or propylene oxide.

Suitable polyetherols are obtained by known processes, for example via anionic polymerization with alkali metal hydroxides or alkali metal alkoxides as catalysts and in the presence of at least one starter molecule comprising 2 to 5, preferably 2 to 4 and more preferably 2 to 3, especially 2 reactive hydrogen atoms in bonded form, or via cationic polymerization with Lewis acids, such as antimony pentachloride or boron trifluoride etherate, from one or more alkylene oxides having 2 to 4 carbon atoms in the alkylene moiety. Useful catalysts further include multimetal cyanide compounds, so-called DMC catalysts. Suitable alkylene oxides include for example tetrahydrofuran, 1,3-propylene oxide, 1,2-butylene oxide, 2,3-butylene oxide and preferably ethylene oxide and/or 1,2-propylene oxide. Alkylene oxides can be used singly, alternatingly in succession or as mixtures. Preference is given to using 1,2-propylene oxide, ethylene oxide or mixtures of 1,2-propylene oxide and ethylene oxide. It is particularly preferable for the polyether polyols to comprise at least 5% by weight and especially at least 10% by weight of ethylene oxide.

The starter molecule used is preferably water or a 2- or 3-hydric alcohol, such as ethylene glycol, 1,2- or 1,3-propanediol, diethylene glycol, dipropylene glycol, 1,4-butanediol, glycerol or trimethylolpropane.

The preferred polyether polyols, particularly preferably polyoxypropylene or polyoxy-propylene-polyoxyethylene polyols, have a functionality of 2 to 5 and more preferably of 2 to 3 and molecular weights of 400 to 9000, preferably 1000 to 8000, more preferably 1500 to 7000 and especially of 2000 to 6000 g/mol.

Chain-extending and/or crosslinking agents (c) can also be used, optionally. The addition of chain-extending and/or crosslinking agents (c) can take place before, together with or after the addition of polyols. Useful chain-extending agents and/or crosslinking agents (c) include substances having a molecular weight of preferably below 400 g/mol and more preferably of 60 to 350 g/mol, chain extenders having 2 isocyanate-reactive hydrogen atoms and crosslinking agents having 3 isocyanate-reactive hydrogen atoms. These can be used individually or in the form of mixtures.

When chain extenders are used, 1,3- and 1,2-propanediol, dipropylene glycol, tripropylene glycol and 1,3-butanediole are particularly preferable.

When chain-extending agents, crosslinking agents or mixtures thereof are used, they are advantageously used in amounts of 1% to 60% by weight, preferably 1.5% to 50% by weight and especially 2% to 40% by weight, based on the weight of polyisocyanates (a), isocyanate-reactive compounds (b) and chain-extending agents and/or crosslinking agents (c).

Isocyanate prepolymers are obtainable by reacting above-described polyisocyanates (a), for example at temperatures of 30 to 100° C. and preferably at about 80° C., with isocyanate-reactive compounds (b) and also optionally chain-extending and/or cross-linking agents (c) to form the prepolymer. For this reaction, polyisocyanate (a), isocyanate-reactive compound (b) and also optionally chain-extending and/or cross-linking agent (c) are preferably mixed together in a ratio of isocyanate groups to isocyanate-reactive groups ranging from 1.5:1 to 15:1 and preferably from 1.8:1 to 8:1. It is particularly preferable for prepolymers to be prepared by mixing polyisocyanates and the compound having isocyanate-reactive groups and chain-extending and/or crosslinking agents together in a ratio such that the NCO content of the prepolymer obtained is in the range from 1.0% to 20% and especially from 2% to 15% by weight, based on the total weight of the isocyanate prepolymer obtained. Subsequently, volatile isocyanates may preferably be removed, preferably by thin-film distillation.

Particularly preferred isocyanate prepolymers are obtained on the basis of MDI isomers and a polyetherol on propylene oxide and/or ethylene oxide. Preferably, the ethylene oxide content is above 10% by weight, based on the total weight of component (b).

Monomeric component (A) may additionally comprise, as further constituents, customary auxiliaries known to a person skilled in the art. Examples are surface-active substances, flame retardants, nucleating agents, oxidation stabilizers, lubricating and demolding aids, dyes and pigments, stabilizers, for example against hydrolysis, light, heat or discoloration, organic and/or inorganic fillers, reinforcing agents and biocides.

Further particulars concerning the abovementioned auxiliary and added substances are discernible from the technical literature, for example from Plastics Additive Handbook, 5th edition, H. Zweifel, ed, Hanser Publishers, Munich, 2001.

Solvent (C) can in principle be one or a mixture of more than one compound, provided solvent (C) is liquid at the temperature and pressure conditions (in brief: dissolution conditions) under which the mixture is provided in step (a). The composition of solvent (C) is chosen such that solvent (C) is capable of dissolving or dispersing, preferably dissolving, the polyfunctional isocyanate (A1). Preferred solvents (C) are a solvent for the polyfunctional isocyanate (A1) and dissolve the latter completely.

Useful solvents (C) include the prior art solvents for isocyanate-based polymers.

Useful solvents (C) include for example dialkyl ethers, cyclic ethers, ketones, alkyl alkanoates, amides such as formamide and N-methylpyrrolidone, sulfoxides such as dimethyl sulfoxide, aliphatic and cycloaliphatic halogenated hydrocarbons, halogenated aromatic compounds and fluorinated ethers. Mixtures of two or more of the afore-mentioned compounds are similarly possible.

Useful solvents (C) further include acetals, especially diethoxymethane, dimethoxy-methane and 1,3-dioxolane.

Dialkyl ethers and cyclic ethers are preferable for use as solvent (C). Preferred dialkyl ethers are especially those having 2 to 6 carbon atoms, especially methyl ethyl ether, diethyl ether, methyl propyl ether, methyl isopropyl ether, propyl ethyl ether, ethyl isopropyl ether, dipropyl ether, propyl isopropyl ether, diisopropyl ether, methyl butyl ether, methyl isobutyl ether, methyl t-butyl ether, ethyl n-butyl ether, ethyl isobutyl ether and ethyl t-butyl ether. Especially tetrahydrofuran, dioxane and tetrahydropyran are preferred cyclic ethers.

Ketones having alkyl groups with up to 3 carbon atoms per substituent are likewise preferable for use as solvent (C). The following ketones are particularly preferable for use as solvent (C): acetone, cyclohexanone, methyl t-butyl ketone and methyl ethyl ketone.

Preferable solvents (C) further include alkyl alkanoates, especially methyl formate, methyl acetate, ethyl formate, butyl acetate and ethyl acetate. Preferred halogenated solvents are described in WO 00/24799, page 4, line 12 to page 5, line 4.

Dialkyl ethers, cyclic ethers, ketones and esters are very particularly preferred for use as solvent (C).

In many cases, particularly suitable solvents (C) result on using two or more mutually completely miscible compounds selected from the aforementioned solvents in the form of a mixture.

The boiling point of solvent (C) is preferably below 100° C., more preferably below 95° C. and above 10° C. and especially below 90° C. and above 25° C.

Particular preference is given to solvents that are water miscible, such as acetone and acetyl acetate.

The solvent (C) is preferably used in such amounts that the level of polyfunctional isocyanate (A1) is less than 40% by weight, preferably less than 30 and greater than 5% by weight, more preferably less than 20 and greater than 8% by weight and especially less than 20 and greater than 10% by weight.

In addition to polyfunctional isocyanate and solvent (C), polyfunctional amines, or alcohols, especially amines or alcohols having a functionality greater than 2 and preferably greater than 2.5 can also be added. Preferably, however, such amines are not added.

The monomeric component (A) is subsequently contacted with water vapor. For this, it is preferable to conduct a stream of water vapor past the monomeric component (A). This is preferably done at elevated temperature, for example at 70 to 200° C. preferably at 80 to 150° C. and more preferably at 95 to 120° C.

Preferably, the monomeric component (A) is applied to a carrier (B) before the step of contacting with water vapor. This carrier (B) is preferably a porous article, preferably a macroporous article. Open-cell foams, fleeces or woven fabrics can be used as carrier (B) for example.

Macroporous is to be understood for the purposes of the present invention as meaning that the average pore diameter is more than 1 micrometer (1000 nm), preferably more than 10 micrometers and more preferably more than 50 micrometers, determined by mercury intrusion measurement to DIN 66133. The value thus determined is a volume-weighted average pore diameter.

Fleeces are non-woven, non-knitted and non-tufted articles of manufacture which are composed of fibers and in which coherency is generally due to the fibers' own adherence. They are also known as nonwovens and they can be fibrous nonwoven webs, spunbonded webs or random-laid webs. Fleeces herein shall also be understood as meaning felts and bonded fibrous nonwoven web fabrics. Fleeces are preferably consolidated mechanically, for example by needling, interlooping or entangling using sharp jets of water or air. Fleeces can also be consolidated adhesively or cohesively. Adhesively consolidated fleeces are obtainable for example by adhering the fibers together using liquid binders or via melting of bonding fibers added to the fleece during production. Cohesively consolidated fleeces are for example by insipiently dissolving the fibers with suitable chemicals and application of pressure.

Suitable fleeces generally have a basis weight of 10 to 2000, preferably 50 to 1000 and especially 100 to 800 g/m² as substrate (i.e., before coating), depending on their chemical composition.

Wovens are articles of manufacture which are composed of crossed fibers, preferably fibers crossed at right angles. Suitable wovens generally have a basis weight of 10 to 2000, preferably 30 to 1000 and especially 50 to 500 g/m² as substrate (before coating), depending on their chemical composition.

In the case of a fleece or a woven fabric, the average pore diameter is preferably to be understood as meaning the average size of the pores due to the spaced-apart fibers of the fleece or woven fabric. The average pore diameter of the fleeces or wovens is likewise determined by mercury intrusion measurement to DIN 66133.

The manufacture of wovens or fleeces on the basis of fibrous materials is known. Useful fibrous materials include any known fibrous materials, such as polymeric fibers, carbon fibers, glass fibers or cellulose fibers, preferably glass fibers.

In a further embodiment, the carrier (B) is an open-cell macroporous foam.

Open-cell is to be understood as meaning in relation to foams that the majority of foam cells are not closed, but intercommunicate with each other. The volume fraction of pores which do not intercommunicate but are closed (non-open-cell or closed-cell fraction) in open-cell foams is preferably less than 50% by volume. It is particularly preferable for the non-open-cell volume fraction of pores in open-cell foams to be at most 30% by volume, for example at most 20% by volume, and especially at most 10% by volume.

The average pore diameter in the case of open-cell foams is preferably to be understood as meaning the average size of pores bounded by walls and/or struts. The average pore diameter is determined as volume-weighted average value using mercury intrusion measurement to DIN 66133, to which the pore diameters recited in this invention for uncoated substrates relate. Suitable foams typically have a density of 3 to 500, preferably 4 to 300 and more preferably 5 to 100 g/dm³, determined to DIN EN ISO 845, before the reaction, depending on their chemical composition (see hereinbelow).

The intrinsic surface area of foams before the reaction is generally up to 30 m²/g, for example from 1 to 20 m²/g, determined using gas adsorption by the BET (Brunauer, Emmet, Teller) method described in DIN 66131.

Considered chemically, the open-cell macroporous foam is preferably constructed on the basis of at least one organic polymer. Herein “on the basis” or “based on” is to be understood as meaning a proportion equal to at least 50% by weight, preferably at least 60%, more preferably at least 70% and especially at least 80% by weight of the substrate.

In principle, all organic polymers capable of being processed into a foam come into consideration as open-cell macroporous foam. When the foam is preferably selected from amino-aldehyde resins, phenol-aldehyde resins, polystyrene, polyvinyl chloride, polyurethanes, polyamides, polyesters, polyolefins and cellulose.

The open-cell macroporous foam is preferably constructed on the basis of aminoplast, especially melamine-formaldehyde. Foams of this type are known to a person skilled in the art or are obtainable by known methods. Basotect® foams from BASF SE are examples of appropriate foams based on melamine-formaldehyde.

The density of the open-cell foam is generally in the range from 3 to 100 g/l and preferably in the range from 5 to 20 g/l. Cell count is typically in the range from 50 to 300 cells/25 mm. Tensile strength is preferably in the range from 100 to 150 kPa and breaking extension in the range from 8 to 20%.

An open-cell foam based on the melamine-formaldehyde (MF) resin preferred as aminoplast is obtainable as described in EP-A 071 672 or EP-A 037 470 by a highly concentrated melamine-formaldehyde precondensate solution or dispersion comprising blowing agent being foamed and cured with hot air, water vapor or by microwave irradiation.

The molar ratio of melamine to formaldehyde is generally less than 1:1.0, and it is preferably between 1:1 and 1:5 and especially between 1:1.3 and 1:1.8. It has been determined that a relatively high sulfite group content combined with a constant melamine-to-formaldehyde ratio results in a higher formaldehyde evolution of the foam. Therefore, the precondensate used should contain virtually no sulfite groups, i.e., the sulfite group content should be below 1%, preferably below 0.1% and especially 0%.

Without treatment, the melamine foam is hydrophilic and readily crumbleable. It can be rendered hydrophobic by chemical modification or aftertreatment and/or more dimensionally stable with reinforcing components, as described in DE-A 10 2007 009127.

The combination of nanoporous foam according to the present invention and foams composed of melamine-formaldehyde leads to nanofoam composites of particularly favorable porosity and density.

For this, the open-cell macroporous foam can be contacted with the monomeric component (A) in a conventional manner. Preferably, the open-cell macroporous foam is impregnated with the solution of the monomeric component (A), for example by drenching, or by adding the monomeric component to the carrier (B) and mechanically agitating the latter, for example by flexing. The procedure adopted is preferably such that the accessible pores become wetted as completely as possible. Here it is also possible for the constituents of the monomeric component (A) to be contacted with the carrier (B) individually and to become mixed during application, but this is not preferable.

The invention further provides a nanoporous foam obtainable by a process according to the present invention and also more particularly a nanoporous composite obtained by contacting a carrier (B) with the monomer solution (A).

A nanofoam composite according to the present invention has outstanding acoustical and thermal insulation properties and therefore is outstandingly useful as insulating material for acoustical and thermal insulation. For example, nanofoam composites according to the present invention can be used in insulation panels, for example under reduced pressure.

A nanofoam composite according to the present invention is further outstandingly useful as filtering material, especially for removing minutest impurities in liquid and gas streams.

A nanofoam composite according to the present invention is likewise useful as carrier of catalysts.

An embodiment of the present invention will now be more particularly described by way of example.

### EXAMPLE

Production of monomeric component (A)

Raw materials:

2588 g of a 1:1 mixture of 4,4 ′ MDI and 2,4 MDI

1487 g of a polyol based on glycerol, propylene oxide and ethylene oxide with an average functionality of 2.5 and a number-average molecular weight of 5170 g/mol and an ethylene oxide content of 20.7% by weight

0.4 g of diglycol bischloroformate (DIBIS)

Apparatus:

A 6 l 4-neck glass reaction flask equipped with fitting heating hood and thermostating device, stirrer and metering container

Protective gas device

Procedure:

Isocyanate and DIBIS are initially charged to the 6 l 4-neck glass reaction flask and thermostated to 80° C. with a heating hood under agitation.

The polyol is added during 10 min via dropping funnel.

The entire reaction takes place under nitrogen blanketing.

The reaction mixture is stirred at 80° C. for 1 h and then cooled down.

The monomeric component (A) now has an NCO content of about 20.4%, a density of about 1.136 g/l at 25° C. and a viscosity of about 325 mPas at 25° C.

Production of nanoporous foam

Raw materials

10 g of Basotect® from BASF SE

10 g of monomeric component (A)

30 g of acetone

Procedure:

The Basotect is weighed into a 5 l metal container with holes in the bottom.

The monomeric component (A) is weighed into a glass beaker and dissolved with the acetone.

The solution is added dropwise to the Basotect in the metal container under agitation.

After further good commixing a round 6 kg weight is placed on the opening of the metal container.

The holey container is suspended in a steam generator, wherein the water vapor passes through the Basotect-monomeric component mixture and causes the system to react. Once there is no longer any detectable acetone odor, the nanoporous foam is removed from the metal container and dried.

The scanning electron microscope shows an open-cell nanoporous foam on the supporting Basotect foam.

1. A process for producing a nanoporous foam, said process comprising:
applying a monomeric component (A) to a carrier (B); and then
contacting the monomeric component (A) with water vapor,
wherein the monomeric component (A) comprises a polyfunctional isocyanate (A1) and a solvent (C).

2. The process of claim 1, wherein said polyfunctional isocyanate (A1) comprises a prepolymer obtained by reacting or mixing at least one polyisocyanate (a) with at least one isocyanate-reactive compound (b) and optionally a chain-extending agent (c), a crosslinking agent (d), or both (c) and (d), wherein said polyisocyanate (a) is used in excess.

3. The process of claim 1, wherein said monomeric component (A) has an isocyanate content of less than 30% by weight.

4. The process of claim 1, wherein said solvent (C) has a boiling point of below 100° C. at atmospheric pressure.

5. (canceled)

6. The process of claim 1, wherein said carrier (B) is an open-cell macroporous foam, which is impregnated with said monomeric component (A).

7. The process according to claim 1, wherein said carrier (B) has a volume-average pore size of 20 to 1000 micrometers.

8. The process of claim 1, wherein said carrier (B) comprises a reactive polycondensation resin.

9. The process of claim 6, wherein said open-cell macroporous foam is a melamine-formaldehyde foam.

10. The process of claim 1, wherein said carrier (B) is a fleece or a woven fabric.

11. The process according to claim 10, wherein said fleece or woven fabric comprises glass fibers.

12. A nanofoam composite obtainable by the process of claim 1.

13-14. (canceled)

15. An article, comprising the nanofoam composite of claim 12, wherein the article is selected from the group consisting of an insulant for thermal insulation, an insulant for acoustical insulation, a filtering material , and a catalyst carrier.
